(19) United States
(12) Patent Application Publication
(10) Pub. No.: US 2019/0358978 A1
(43) Pub. Date: Nov. 28, 2019

(54) INSPECTING APPARATUS, A PRINTING APPARATUS HAVING THE SAME, AND A READING APPARATUS

(71) Applicant: SCREEN HOLDINGS CO., LTD., Kyoto (JP)

(72) Inventors: Takaharu Yamamoto, Kyoto (JP); Atsushi Imamura, Kyoto (JP); Tomotaka Kato, Kyoto (JP)

(21) Appl. No.: 16/419,501

(22) Filed: May 22, 2019

(30) Foreign Application Priority Data
May 25, 2018 (JP) 2018-100508

(51) Int. Cl. B41J 29/393; B41J 15/04

(52) U.S. Cl. CPC B41J 29/393; B41J 15/04

(57) ABSTRACT

An inspecting apparatus for inspecting an image formed on a printing medium. The apparatus has a transport roller for transporting the printing medium with the image printed thereon, with the transport roller contacting a surface opposite an image-forming surface of the printing medium, and a reader for reading the image from a part of the printing medium in contact with the transport roller. The transport roller is formed of aluminum or an aluminum alloy, with numerous recesses and numerous projections formed on a surface thereof, and having a needlelike construction with an aspect ratio from 2 to 30 inclusive

### BACKGROUND OF THE INVENTION

### (1) Field of the Invention

This invention relates to an inspecting apparatus for reading a printed surface of a printing medium transported by a transport roller to inspect a print condition, a printing apparatus having the same, and a reading apparatus.

### (2) Description of the Related Art

Conventionally, this type of apparatus includes a transport roller for transporting web paper with images printed thereon which are an object under inspection, and a reader opposed to the transport roller across the web paper and facing a printed surface (see Japanese Unexamined Patent Publication No. 2012-206454, for example).

The inspecting apparatus constructed in this way has the transport roller contacting a surface opposite the printed surface. The part in contact with this transport roller is irradiated by light from a light source of the reader, and light reflected therefrom and incident on the reader results in an acquisition of an image of the printed surface. Image data of the printed surface acquired is put to an image processing such as a binarizing process for image inspection. In order to cope with transportation of the web paper having various widths, and to be capable of normal transportation even when the web paper skews, the transport roller has a shaft length slightly longer than a maximum width of transportable web paper.

However, the conventional example with such construction has the following problem.

That is, the conventional apparatus has a problem of being unable to carry out inspection accurately due, for example, to the image printed on the web paper being read with density lower than actual density which is caused by the light from the light source reflecting on the surface of the transport roller. This tendency becomes prominent especially in end regions of the web paper.

### SUMMARY OF THE INVENTION

This invention has been made having regard to the state of the art noted above, and its object is to provide an inspecting apparatus capable of accurately inspecting an image printed on a printing medium, which is achieved by devising a transport roller, a printing apparatus having the same, and a reading apparatus.

To fulfill the above object, this invention provides the following construction.

This invention provides an inspecting apparatus for inspecting an image formed on a printing medium, the apparatus having a transport roller for transporting the printing medium with the image printed thereon, with the transport roller contacting a surface opposite an image-forming surface of the printing medium, and a reader for reading the image from a part of the printing medium in contact with the transport roller; wherein the transport roller is formed of aluminum or an aluminum alloy, with numerous recesses and numerous projections formed on a surface thereof, and having a needlelike construction with an aspect ratio from 2 to 30 inclusive.

According to this invention, the transport roller formed of aluminum or an aluminum alloy has numerous recesses and numerous projections formed by chemical etching process, for example, and has a needlelike construction formed thereon. This construction has an aspect ratio from 2 to 30 inclusive. With such a needlelike construction, light emitted to the transport roller is absorbed by the needlelike construction, thereby inhibiting reflection from the transport roller to the reader. Since the trouble due to the reflection from the transport roller is eliminated, the image printed on the printing medium can be inspected accurately.

In this invention, it is preferred that the projections have ridgelines forming angles of 60 degrees or less with lines perpendicular to the surface of the transport roller.

The light emitted to the surface of the transport roller and having entered the recesses can be reduced as regards re-emission to the ambient in particular.

In this invention, it is preferred that the transport roller has a film of conductive metal formed on a surface of the needlelike construction.

The printing medium may produce powder with transportation of the printing medium, and such powder may adhere to the transport roller by static electricity. Then, the powder may enter the recesses of the needlelike construction to lower its light-absorbing performance. However, the adhesion by static electricity can be prevented by the film of conductive metal, thereby to prevent lowering of the light-absorbing performance. Consequently, the performance can be maintained over a long period of time.

In this invention, it is preferred that the film of conductive metal is black in color.

Black in color can further inhibit light reflection on the surface of the transport roller.

In another aspect of this invention, a printing apparatus for printing on a printing medium, comprises a print head for forming an image on the printing medium; and an inspecting device for inspecting the image formed on the printing medium, the inspecting device having a transport roller for transporting the printing medium with the image printed thereon, with the transport roller contacting a surface opposite an image-forming surface of the printing medium, and a reader for reading the image from a part of the printing medium in contact with the transport roller; wherein the transport roller is formed of aluminum or an aluminum alloy, with numerous recesses and numerous projections formed on a surface thereof, and having a needlelike construction with an aspect ratio from 2 to 30 inclusive.

According to this invention, the inspecting device includes the transport roller formed of aluminum or an aluminum alloy and having numerous recesses and numerous projections formed by chemical etching process, for example, and a needlelike construction formed thereon. This construction has an aspect ratio from 2 to 30 inclusive. With such a needlelike construction, light emitted to the transport roller is absorbed by the needlelike construction, thereby inhibiting reflection from the transport roller to the reader. Since the trouble due to the reflection from the transport roller is eliminated, the image printed on the printing medium can be inspected accurately.

In a further aspect of this invention, a reading apparatus is provided for reading an image from a part of a printing medium in contact with a transport roller while transporting the printing medium with the image printed thereon, with the transport roller contacting a surface opposite an image-forming surface of the printing medium. The apparatus comprises a reading device for reading the image; an optical path for guiding light reflected from the image to the reading device; and a constituent member located optically adjacent the optical path; wherein the constituent member is formed of aluminum or an aluminum alloy, with numerous recesses and numerous projections formed on a surface thereof at least facing the optical path, and having a needlelike construction with an aspect ratio from 2 to 30 inclusive.

According to this invention, the constituent member formed of aluminum or an aluminum alloy has numerous recesses and numerous projections formed by chemical etching process, for example, on a surface thereof at least facing the optical path, and has a needlelike construction formed thereon. This construction has an aspect ratio from 2 to 30 inclusive. With such a needlelike construction, light emitted to the optical path and then emitted to the constituent member to produce stray light is absorbed by the needlelike construction, thereby suppressing stray light in the optical path. Since the trouble due to the reflection from the constituent member is eliminated, the image printed on the printing medium can be accurately read by the reading device.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a side view showing an outline construction of an inkjet printing system according to an embodiment;

FIG. 2 is a schematic view showing a positional relationship between a transport roller, web paper, and so on;

FIG. 3 is an enlarged sectional view of a surface of the transport roller;

FIG. 4 is a view in vertical section showing an example of construction of a reader;

FIG. 5 is a schematic view illustrating light falling on the transport roller; and

FIG. 6 is a table showing results of comparison between conventional technique and this invention.

### DESCRIPTION OF THE PREFERRED EMBODIMENTS

A preferred embodiment of this invention will be described in detail hereinafter with reference to the drawings.

One embodiment of this invention will be described hereinafter with reference to the drawings.

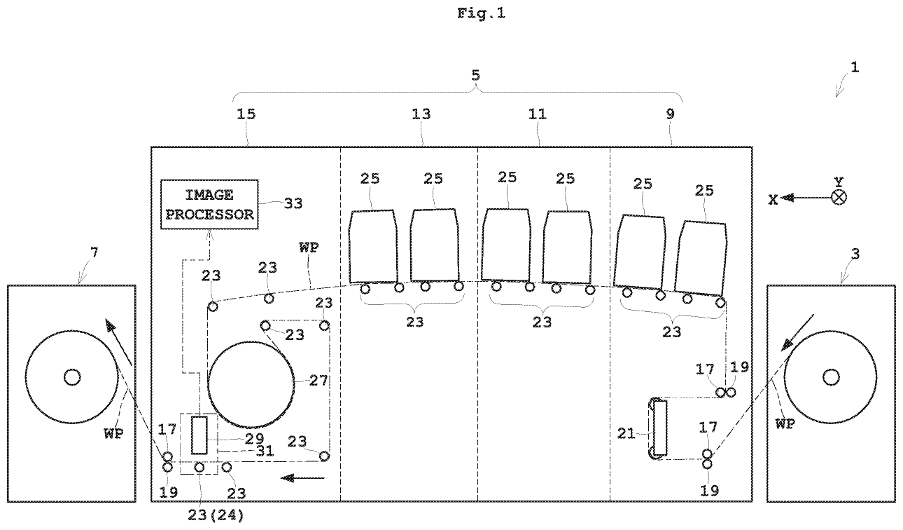

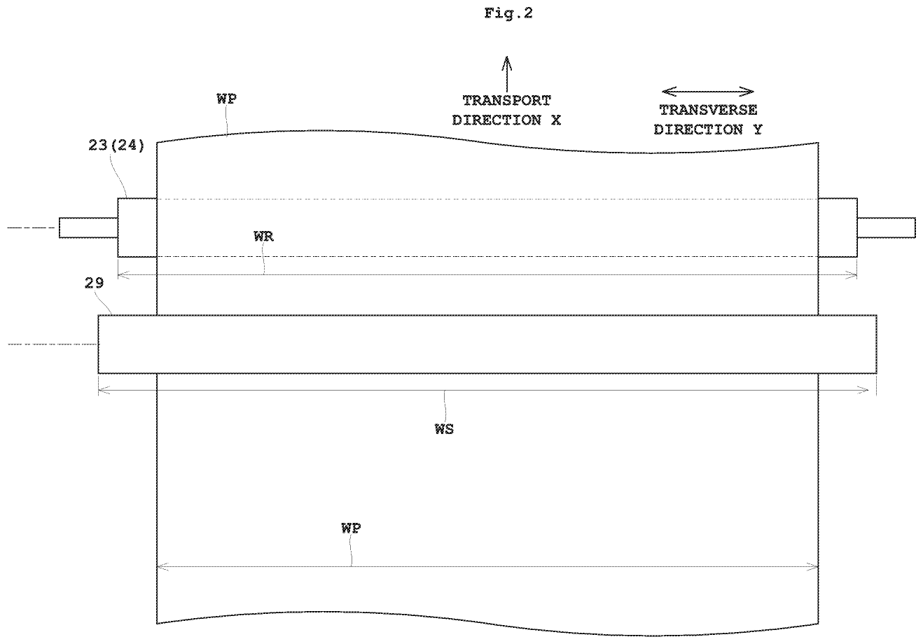

FIG. 1 is a side view showing an outline construction of an inkjet printing system according to the embodiment. FIG. 2 is a schematic view showing a positional relationship between a transport roller 23, web paper WP, and so on, which is a plan view depicting the transport roller 23, a reader 29, and so on seen from directly above the web paper WP.

This embodiment will be described taking for example a printing apparatus of the inkjet printing mode. The inkjet printing system 1 according to this embodiment includes a paper feeder 3, an inkjet printing apparatus 5, and a takeup roller 7.

The paper feeder 3 holds a roll of web paper WP to be rotatable about a horizontal axis, and unwinds the web paper WP to feed it to the inkjet printing apparatus 5. The inkjet printing apparatus 5 carries out printing on the web paper WP. The takeup roller 7 winds up the web paper WP printed in the inkjet printing apparatus 5 into a roll form around a horizontal axis. Regarding the supply side of web paper WP as upstream and the discharge side of web paper WP as downstream, the paper feeder 3 is located upstream of the inkjet printing apparatus 5, and the takeup roller 7 downstream of the inkjet printing apparatus 5.

The above web paper WP corresponds to the “printing medium” in this invention.

The inkjet printing apparatus 5 has an entrance unit 9, a first intermediate unit 11, a second intermediate unit 13, and an exit unit 15 arranged in order from adjacent the paper feeder 3. The inkjet printing apparatus 5 may be constructed by selecting and connecting these units 9, 11, 13 and 15 as appropriate, but the apparatus according to this embodiment has all these units.

The entrance unit 9 includes a drive roller 17 and a nip roller 19, an edge position controller 21, another drive roller 17 and another nip roller 19, four transport rollers 23, and two inkjet heads 25 arranged in order from adjacent the paper feeder 3. The drive rollers 17 and nip rollers 19 take in the web paper WP from the paper feeder 3. The edge position controller 21 will automatically correct position when the web paper WP meanders, thereby to transport the web paper WP properly. The four transport rollers 23 have a function to contact the lower surface of web paper WP and smoothly transport the web paper WP. The inkjet heads 25 have a function to dispense ink droplets to the web paper WP to form print images thereon. Here, an upstream one of the inkjet heads 25 dispenses an ink of black (K), and the other, downstream inkjet head 25 dispenses an ink of cyan (C). The four transport rollers 23 have upper edges thereof constituting a transport path for transporting the web paper WP.

The first intermediate unit 11 has four transport rollers 23 and two inkjet heads 25. The two inkjet heads 25 include an upstream inkjet head 25 which dispenses an ink of magenta (M), for example, and a downstream inkjet head 25 which dispenses an ink of yellow (Y).

The second intermediate unit 13 has the same construction as the above first intermediate unit 11. That is, it has four transport rollers 23 and two inkjet heads 25. Of the two inkjet heads 25, the upstream one dispenses an ink in gold color, for example, and the downstream one dispenses an overcoat material. The overcoat material covers and protects the surfaces of print images.

The exit unit 15 has transport rollers 23, a heat drum 27, transport rollers 23, a reader 29, and a drive roller 17 and a nip roller 19 arranged in order from an upstream portion of the transport path. The heat drum 27 has a heater mounted inside and is rotatable with transportation of the web paper WP. The heat drum 27 heats and dries ink droplets dispensed to the web paper WP. The reader 29 reads and digitizes print images formed on the web paper WP. The reader 29 constitutes an inspecting device 31 with the transport roller 23 located in a lower position opposed to the reader 29 across the web paper WP. In this embodiment, the transport roller 23 located opposite the reader 29 is particularly called the transport roller 24. Image data obtained by the reader 29 is given to an image processor 33. The image processor 33 performs image processing such as a binarizing process on the image data, and based on results thereof, determines the quality of images printed on the web paper WP.

The above inkjet heads 25 correspond to the “printing heads” in this invention. The inspecting device 31 corresponds to the “inspecting apparatus” and “inspection device” in this invention. The reader 29 corresponds to the “reading apparatus” in this invention.

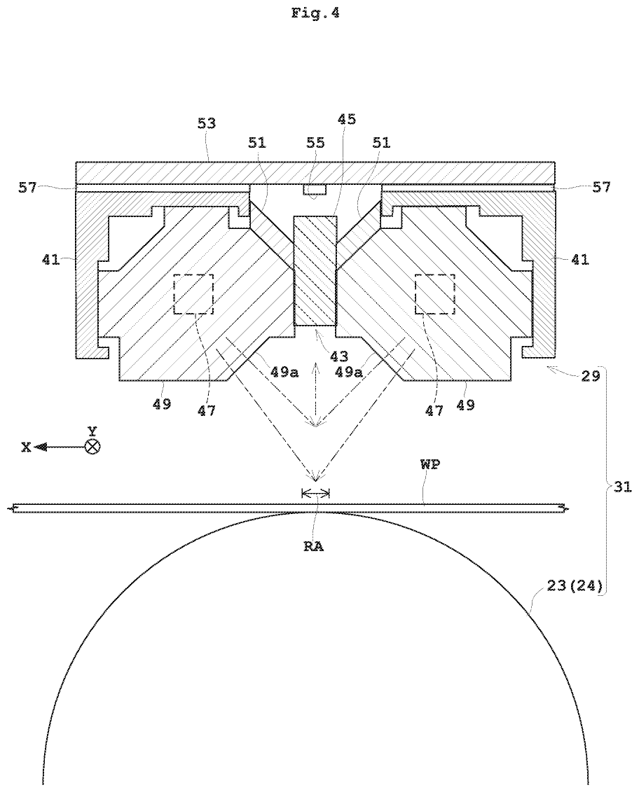

As shown in FIG. 2, the reader 29 is located in an upper position opposed to the transport roller 24 across the web paper WP. Although, in FIG. 2, for expediency of illustration, the reader 29 and transport roller 24 are shown staggered instead of being opposed to each other, but actually the reader 29 and transport roller 24 are in a positional relationship of being vertically opposed to each other as seen from FIG. 1. That is, the reader 29 is located to have a read area RA (see FIG. 4) indicating a reading range for covering a print surface corresponding to a contact between the web paper WP and transport roller 24. Since the read area RA is set to a position corresponding to the contact between the web paper WP and transport roller 24, a read portion of the printed surface of the web paper WP will not slur up and down by transportation. This provides an advantage that the printed surface can be read with high accuracy even if the reader 29 has a shallow depth of field.

In this embodiment, the transport direction of web paper WP is affixed with sign X, and the transverse direction of web paper WP perpendicular to the transport direction X is affixed with sign Y. Here, the widths in the transverse direction Y of the web paper WP, transport roller 24, and reader 29 which are affixed with signs WP, WR and WS, respectively, are in a relationship WS>WR>WP. That is, the web paper WP may have various widths, and the width WR of the transport roller 23 has the width WR slightly larger than the width WP of the web paper WP to be able to cope with a maximum width and skewing of the web paper WP. It is necessary for the reader 29 to perform reading in a way to cover opposite lateral ends of the web paper WP, even at times of skewing. The width WS of the reader 29 and its read area RA are larger than the width WP of the web paper WP. Consequently, the widths in the transverse direction Y of the web paper WP, transport roller 24, and reader 29 are in the above-noted order of size relationship.

The transport roller 24 is formed of aluminum or an aluminum alloy. The transport roller 24 has a needlelike construction formed on an outer circumferential surface for contacting the web paper WP. The needlelike construction here has numerous recesses and numerous projections, with an aspect ratio from 2 to 30 inclusive.

The aspect ratio here refers to a ratio between the depth and opening width (depth/opening width) of the recesses. When the aspect ratio is less than the above, the opening width is large relative to the depth of the recesses and there is a possibility that light incident in the recesses may be emitted again. On the other hand, when the aspect ratio exceeds the above range, the construction cannot be practical. That is, in chemical etching, the longer etching time can form the deeper recesses. However, since the tips of the projections are etched at the same time, it is difficult to form the needlelike construction with an aspect ratio exceeding the above range by extending the time of an etching process.

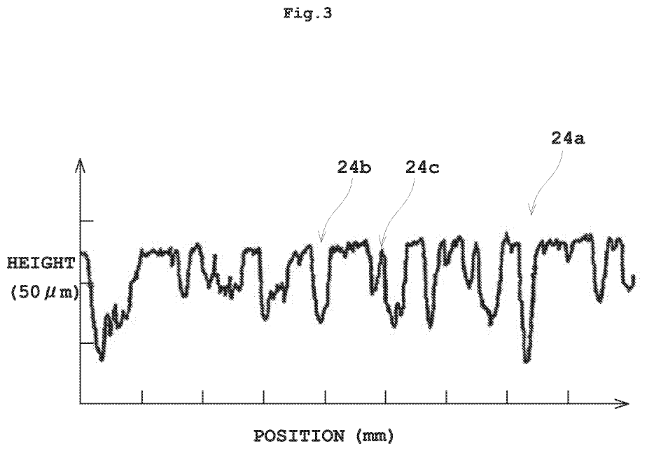

FIG. 3 is an enlarged sectional view of a surface 24a of the transport roller 24. As shown in FIG. 3, the surface 24a of the transport roller 24 which has the needlelike construction formed of numerous recesses 24b and numerous projections 24c. It is thought that the smaller angle the ridgeline of a projection 24c forms with a line perpendicular to the surface 24a, the less light is reflected from the surface 24a. For example, this angle being 60 degrees or less (preferably 30 degrees or less), in particular, can reduce a re-emission to the ambient of light having entered the recesses 24b.

This needlelike construction is formed, for example, by preparing the outer circumferential surface of transport roller 24 through a corrugating process or blasting process, and thereafter carrying out a surface roughening process through chemical etching. It is preferable to use hydrofluoric acid in the chemical etching. Hydrofluoric acid is suited for processing the surface of the transport roller 24 into a needlelike construction because of its highly anisotropic property in etching rate relative to the surface of aluminum or aluminum alloy to realize a greater etching effect in the depth direction than in the width direction.

Preferably, the above surface roughening process is carried out as follows.

The transport roller 24 is degreased first, after the degreasing a first etching is carried out in a caustic soda solution, and after the etching a desmutting process is carried out with nitric acid. Subsequently, iron group metal salt and aluminum or aluminum alloy are immersed in a corrosive mixed water solution of acid to deposit metallic particles by displacement reaction. Then, a second etching is carried out by immersion in the caustic soda to form a coarse unevenness on the surface. A desmutting process is carried out with nitric acid, electrolysis is carried out in a nitric acid solution after the desmutting process to form an alumite film, and then the thickness of a barrier layer is adjusted. Further, a secondary electrolysis is carried out in a sulfuric acid solution including metal salt compounds such as nickel, cobalt, silver, copper, tin, zinc, and chromium, whereby a film of conductive metal, i.e. conductive alumite, with an electric resistance value adjusted to 10³-10⁹ Ωcm is formed to adhere to the surface in a way not to close the recesses of the unevenness.

It is desirable that the above film of conductive metal is black in color. What is formed on the surface of transport roller 24 is not paint or the like but the film of conductive metal, which can give high durability to the transport roller 24. Since the film of conductive metal is black, light reflection on the surface of the transport roller 24 can be further inhibited.

The reader 29 will now be described in detail with reference to FIG. 4. FIG. 4 is a view in vertical section showing an example of construction of the reader 29.

The reader 29 includes two frames 41, an optical path 43, a lens 45, four light sources 47, two light guides 49, a holder 51, a sensor substrate 53, and a sensor IC 55. The reader 29 has a long axis extending in the transverse direction Y in FIG. 4.

The two frames 41 are spaced from each other in the transport direction X with the optical path 43 in between. The lens 45 is located in the optical path 43. The lens 45 is in the form of a rod lens array or microlens array. The frames 41 hold the light guides 49, respectively. Each light guide 49 has the light sources 47 on opposite end surfaces in the transverse direction Y. Although there are four light sources 47 in total, FIG. 4 shows only two for reasons of illustration. The light sources 47 are light emitting diodes, for example. The light guides 49 are formed of a resin optically transparent to the light of light sources 47. Each light guide 49 has an exit plane 49a formed to face the read area RA. The light of the light sources 47 is emitted from this exit plane 49a toward the read area RA.

The holder 51 stably holds the lens 45 in the optical path 43. The sensor substrate 53 is located above the lens 45 and is attached to the frames 41 through mounting members 57. The sensor IC 55 is disposed on a lower surface of the sensor substrate 53 right above the lens 45. The sensor IC 55 is a CIS (contact image sensor), for example. The CIS, which is low cost compared with a CCD, has a shallow depth of field. Signals detected by the sensor IC 55 are outputted to the image processor 33.

Of the reader 29 constructed as described above, the frames 41, sensor substrate 53, holder 51, and mounting members 57 are formed of aluminum or aluminum alloy. These components have needlelike constructions formed at least on surfaces thereof optically adjacent the optical path 43. That is, needlelike constructions and films of conductive metal are formed in locations facing the optical path 43 through the light guides 49 or facing the optical path 43 through the lens 45. These needlelike constructions and films of conductive metal are the same as those on the surface of the transport roller 24 described hereinbefore.

Being optically adjacent noted above refers to being adjacent through the members transparent to the light from the light sources 47 or through space. The optically adjacent constituent members are members which may guide light to the optical path 43 or to which light may be guided from the optical path 43. Such constituent members do not need to contact the optical path 43 physically.

The above sensor IC 55 corresponds to the “reading device” in this invention. The above frames 41, sensor substrate 53, holder 51, and mounting members 57 correspond to the “constituent members” in this invention.

With the reader 29 constructed as described above, the sensor IC 55 detects light reflected from the web paper WP, of the light emitted from the light sources 47 and from the exit planes 49a to the read area RA. At this time, with the conventional technique, the following problems can be caused by reflection from a transport roller 24 not having been treated with the nonreflective process described above.

(1) Density Variations of Transport Roller Texture

The transport roller 24 has a linear pattern formed on the surface thereof due to its manufacturing method. This linear pattern is minute enough to have no influence on transportation of the web paper WP, but optically the pattern may have an adverse influence. That is, when the web paper WP is thin paper, the pattern on the surface of the transport roller 24 may be read by the sensor IC 55 along with an image on the web paper WP. Consequently, there occurs a problem that the reader 29 cannot accurately read the density of the image, making an accurate inspection impossible.

(2) Overshoot at Boundaries

The light from the light sources 47 may reflect strongly from the surface of the transport roller 24 present outward in the transverse direction Y of an end of the web paper WP, and such light may reach the sensor IC 55. Thus, due to the reflection from the transport roller 24, the reader 29 reads the density of the image printed especially adjacent the end of the web paper WP to be lower than an actual density, which causes a problem of making an accurate inspection impossible.

(3) Light Falling on Transport Roller

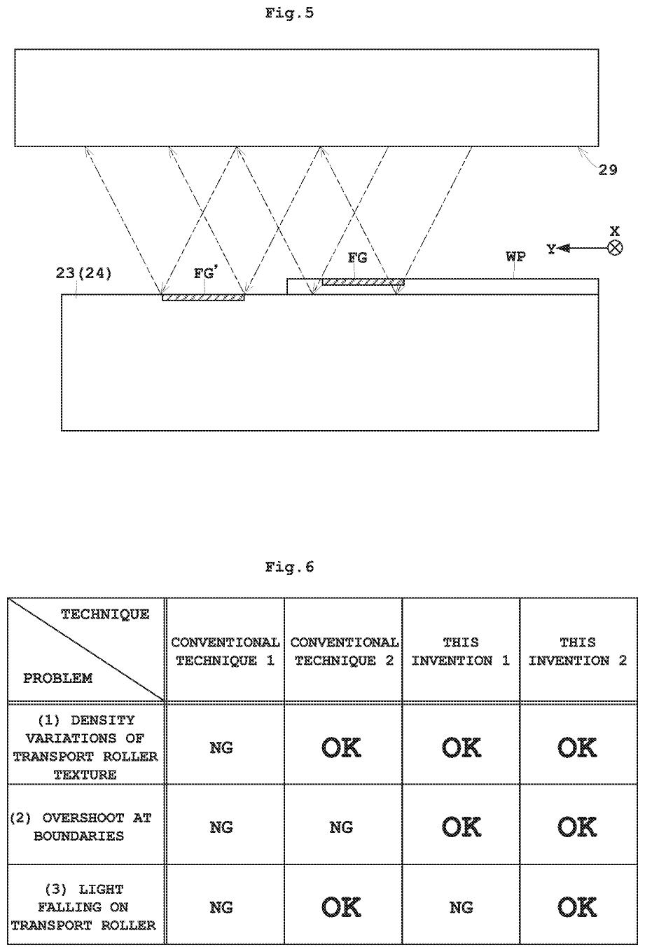

The light transmitted through a portion adjacent an end of the web paper WP reflects between the transport roller 24 and the lower surfaces of the light guides 49, and falls on an end region of the transport roller 24 not covered by the web paper WP, to be detected by the sensor IC 55, which results in an adverse influence. Reference is now made to FIG. 5. FIG. 5 is a schematic view illustrating light falling on the transport roller 24.

The light emitted from the reader 29 passes through a thin web paper WP, and reflects toward the reader 29. At this time, an image FG formed on the web paper WP may be projected to the end region of the transport roller 24 not covered by the web paper WP, to form a projected image FG′ thereon. Then, the projected image FG′ on the transport roller 24 may be detected by the reader 29. This exerts an adverse influence on the image processing by the image processor 33, which causes a problem of making an accurate inspection impossible.

In the ink jet printing system 1 according to this embodiment, the transport roller 24 has a needlelike construction formed thereon. With such a needlelike construction, the light emitted from the reader 29 to the transport roller 24 is absorbed by the needlelike construction, thereby to be able to inhibit reflection from the transport roller 24 to the reader 29. Since the trouble due to the reflection from the transport roller 24 is eliminated, an image printed on the web paper WP can be inspected accurately. As a result, print quality can be improved.

The web paper WP may produce powder with transportation of the web paper WP, and such powder may adhere to the transport roller 24 by static electricity. Then, the powder may enter the recesses of the needlelike construction to lower its light-absorbing performance. However, since the adhesion by static electricity can be prevented by the film of conductive metal, thereby to prevent lowering of the light-absorbing performance. Consequently, performance can be maintained over a long period of time.

A comparison is made here between conventional technique and this invention with reference to FIG. 6. FIG. 6 is a table showing results of the comparison between conventional technique and this invention.

In this table, conventional technique 1 is a case where the transport roller 24 is not treated at all. Conventional technique 2 is a case where the transport roller 24 has been treated with a black alumite process. This invention 1 is a case where only the above-described transport roller 24 has only the needlelike construction formed thereon. This invention 2 is a case where the transport roller 24 has the film of conductive metal coated thereon in addition to the needlelike construction as in the foregoing embodiment.

This table includes problems arranged in order of priority. That is, they are problem (1), problem (2), and problem (3) in descending order of priority. Thus, when what is low in priority is OK but what is higher in priority is NG, the technique is determined, from a comprehensive point of view, to be unable to solve the problem. On the other hand, when what is low in priority is NG but what is higher in priority is OK, the technique is determined, from the comprehensive point of view, to be able to solve the problem.

It is clear from the above points that this invention 1 and this invention 2 can comprehensively solve the technical problems in this invention. On the other hand, conventional technique 2, since it is determined NG for problem (2) although OK for problem (3), cannot comprehensively solve the technical problems in this invention.

In this embodiment, the constituent members of the reader 29 located optically adjacent the optical path 43 have needlelike constructions formed on the surfaces thereof at least facing the optical path 43. With these needlelike constructions, part of the light incident on the optical path 43 may fall on the constituent members optically adjacent the optical path 43 and turn into stray light. Since the needlelike constructions absorb such incident light to suppress the stray light in the optical path 43. Thus, the trouble due to the reflection from the constituent members optically adjacent the optical path 43 is eliminated, thereby allowing the image printed on the web paper WP to be accurately read by the sensor IC 55.

The powder produced with transportation of the web paper WP may enter the frames 41 and other members and adhere thereto by static electricity. Then, there is a possibility that the powder may enter the recesses of the needlelike constructions to lower the light-absorbing performance thereof. However, the adhesion by static electricity can be prevented by the film of conductive metal, thereby preventing the lowering of the light-absorbing performance. Consequently, the performance of the reader 29 can be maintained over a long period of time.

This invention is not limited to the foregoing embodiment, but may be modified as follows:

(1) The foregoing embodiment has been described taking the web paper WP as an example of printing media, but this invention is not limited to such printing medium. Other printing media include film and cut sheet paper, for example.

(2) The foregoing embodiment has been described taking the inkjet printing apparatus 5 as an example of printing apparatus. This invention is not limited to an inkjet type printing apparatus. That is, any printing mode will do as long as the printing apparatus has an inspection unit for inspecting images on a printing medium by using reflected light. The printing mode may be a laser mode or thermal transfer mode, for example.

(3) In the foregoing embodiment, the transport roller 24 has a film of conductive metal formed thereon in addition to a needlelike construction. However, the film of conductive metal is not essential.

(4) In the foregoing embodiment, the sensor IC 55 of the reader 29 is a CIS, which may be replaced with a CCD or other image sensor.

(5) In the foregoing embodiment, the reader 29 has light sources 47. However, the light sources 47 are not indispensable to the reader 29. For example, the inkjet printing apparatus 5 may have a light source, and images may be read with light from this light source.

(6) In the foregoing embodiment, the constituent members of the reader 29 optically adjacent the optical path 43 have needlelike constructions and films of conductive metal formed thereon. However, where there is no problem due to stray light in the reader 29, it is not necessary to employ such construction for the reader 29. Further, the needlelike constructions and films of conductive metal are formed at least on the surfaces, optically adjacent the optical path 43, of the frames 41, sensor substrate 53, holder 51, and mounting members 57 of the reader 29. However, the needlelike constructions and films of conductive metal may be formed on entire surfaces of these constituent members.

This invention may be embodied in other specific forms without departing from the spirit or essential attributes thereof and, accordingly, reference should be made to the appended claims, rather than to the foregoing specification, as indicating the scope of the invention.

What is claimed is:

1. An inspecting apparatus for inspecting an image formed on a printing medium, the apparatus having a transport roller for transporting the printing medium with the image printed thereon, with the transport roller contacting a surface opposite an image-forming surface of the printing medium, and a reader for reading the image from a part of the printing medium in contact with the transport roller;
wherein the transport roller is formed of aluminum or an aluminum alloy, with numerous recesses and numerous projections formed on a surface thereof, and having a needlelike construction with an aspect ratio from 2 to 30 inclusive.

2. The inspecting apparatus according to claim 1, wherein the projections have ridgelines forming angles of 60 degrees or less with lines perpendicular to the surface of the transport roller.

3. The inspecting apparatus according to claim 1, wherein the transport roller has a film of conductive metal formed on a surface of the needlelike construction.

4. The inspecting apparatus according to claim 2, wherein the transport roller has a film of conductive metal formed on a surface of the needlelike construction.

5. The inspecting apparatus according to claim 3, wherein the film of conductive metal is black in color.

6. The inspecting apparatus according to claim 4, wherein the film of conductive metal is black in color.

7. A printing apparatus for printing on a printing medium, comprising:
a print head for forming an image on the printing medium; and
an inspecting device for inspecting the image formed on the printing medium, the inspecting device having a transport roller for transporting the printing medium with the image printed thereon, with the transport roller contacting a surface opposite an image-forming surface of the printing medium, and a reader for reading the image from a part of the printing medium in contact with the transport roller;
wherein the transport roller is formed of aluminum or an aluminum alloy, with numerous recesses and numerous projections formed on a surface thereof, and having a needlelike construction with an aspect ratio from 2 to 30 inclusive.

8. The printing apparatus according to claim 7, wherein the projections have ridgelines forming angles of 60 degrees or less with lines perpendicular to the surface of the transport roller.

9. The printing apparatus according to claim 7, wherein the transport roller has a film of conductive metal formed on a surface of the needlelike construction.

10. The printing apparatus according to claim 8, wherein the transport roller has a film of conductive metal formed on a surface of the needlelike construction.

11. The printing apparatus according to claim 9, wherein the film of conductive metal is black in color.

12. The printing apparatus according to claim 10, wherein the film of conductive metal is black in color.

13. A reading apparatus for reading an image from a part of a printing medium in contact with a transport roller while transporting the printing medium with the image printed thereon, with the transport roller contacting a surface opposite an image-forming surface of the printing medium;
the apparatus comprising:
a reading device for reading the image;
an optical path for guiding light reflected from the image to the reading device; and
a constituent member located optically adjacent the optical path;
wherein the constituent member is formed of aluminum or an aluminum alloy, with numerous recesses and numerous projections formed on a surface thereof at least facing the optical path, and having a needlelike construction with an aspect ratio from 2 to 30 inclusive.

14. The reading apparatus according to claim 13, wherein the projections have ridgelines forming angles of 60 degrees or less with lines perpendicular to the surface of the transport roller.

15. The reading apparatus according to claim 13, wherein the transport roller has a film of conductive metal formed on a surface of the needlelike construction.

16. The reading apparatus according to claim 14, wherein the transport roller has a film of conductive metal formed on a surface of the needlelike construction.

17. The reading apparatus according to claim 15, wherein the film of conductive metal is black in color.

18. The reading apparatus according to claim 16, wherein the film of conductive metal is black in color.
